(19) United States
(12) Patent Application Publication
(10) Pub. No.: US 2014/0170001 A1
(43) Pub. Date: Jun. 19, 2014

(54) VACUUM SYSTEM

(71) Applicant: Pfeiffer Vaccum GmbH, Asslar (DE)

(72) Inventors: Tobias Stoll, Hohenahr (DE); Michael Schweighoefer, Schoeffengrund (DE)

(73) Assignee: Pfeiffer Vacuum GmbH, Asslar (DE)

(21) Appl. No.: 14/089,904

(22) Filed: Nov. 26, 2013

(30) Foreign Application Priority Data
Dec. 18, 2012 (DE) 102012112492.2

(51) Int. Cl. F04B 37/14

(52) U.S. Cl. CPC F04B 37/14
USPC 417/437

(57) ABSTRACT

A vacuum system includes at least one recipient having a housing and at least one outlet opening for evacuating the recipient, a vacuum pump connected with the at least one outlet opening of the at least one recipient for evacuating same, an attachment provided between the vacuum pump and the recipient housing and formed as an intermediate piece, with the attachment being fixedly and vacuum-tightly secured on the recipient, and the vacuum pump being fixedly and releasably secured to the attachment at an end of the attachment opposite the recipient, and at least one O-ring sealing provided between the attachment end opposite the recipient and the vacuum pump for sealing the vacuum pump, with the O-ring sealing being formed as an elastomeric O-ring.

### BACKGROUND OF THE INVENTION

1. Field of the Invention

The invention relates to a vacuum system including a vacuum pump and at least one to-be-evacuated recipient.

2. Description of the Prior Art

The state of the art (DE 24 16 808 A1) discloses a sealing element for vacuum purposes. The known sealing element is formed of metal because sealing elements which are formed of an elastomeric material are not heat-resistant and, therefore, cannot be used at high temperatures. In particular, when the recipient becomes heated, the elastomeric sealing elements become unusable because these sealing elements either produce gas and, thus, “contaminate” the vacuum, or the elastomeric sealing elements become damaged upon being heated, whereby sealing is not any more effective.

The drawback of the state-of-the art metal sealing elements consists in that they, as a rule, can be used only once or, at most, several times because the metal does not have the advantage of the elastomeric material, namely, an elastic deformability. Therefore, with each strong deformation, a new sealing element should be used.

Because the metal sealing elements are often formed of an expensive material (copper, indium, gold or the like), the costs of the metal sealing elements are relatively high.

State of the art (DE 24 16 808 A1) suggests to form a metal sealing ring and a centering ring as a spring ring with a radial slot. However, this shape is very expensive and, therefore, this sealing element is very costly.

Known are UHV (ultra high vacuum)—flanges. These flanges have cutting edges and, e.g., copper sealing elements. Between two flanges, a copper ring is arranged. The concentrically extending cutting edges of the flanges penetrate in the copper and form a metal sealing which is characterized by an extremely low leakage and permeability and a high temperature resistance. These flanges are also called Conflat® flanges (registered trade mark of the firm Agilent Technologies Inc., U.S.A.) or CF-flanges. The drawback of these flanges consists in that they act on the metal sealing elements. Because of the lasting deformation of the metal sealing elements, their multiple use is not any possible. Thus, they can only be used once. In addition, for strength reasons, it is necessary to use stainless steel instead, e.g., of aluminum.

The object of the invention is to provide an interface of a vacuum system and which is optimal with respect to weight, costs, and vacuum capacity and which can be used with a heatable UHV-chamber. A further object of the invention is an O-ring sealing element for a vacuum system and which is formed of an elastomeric material and despite of that does not contaminate ultra high vacuum.

### SUMMARY OF THE INVENTION

These and other objects of the present invention which will become apparent hereinafter, are achieved by providing a vacuum system including at least one recipient having a housing and at least one outlet opening for evacuating the recipient, a vacuum pump connected with the at least one outlet opening of the at least one recipient for evacuating same, an attachment provided between the vacuum pump and the recipient housing and formed as an intermediate piece, with the attachment being fixedly and vacuum-tightly secured on the recipient, and the vacuum pump being fixedly and releasably secured to the attachment at an end of the attachment opposite the recipient, and at least one O-ring sealing element provided between the attachment end opposite the recipient and the vacuum pump for sealing the vacuum pump, the O-ring sealing element being formed as an elastomeric O-ring.

The advantage of the inventive structure consists in that an economical elastomeric O-ring can be used as an O-ring sealing element which nevertheless does not contaminate the ultra vacuum.

The advantage of the inventive vacuum system consists in that by providing of an attachment on the recipient housing, the sealing element is displaced in the direction from forevacuum to a high pressure region. When the UHV-region becomes heated, the O-ring sealing element due to the axial spacing which results from the arrangement of the attachment between the recipient and the vacuum pump, is not stressed too much.

It is particularly advantageous when the attachment is formed of stainless steel or aluminum or any other material which has advantageously a low heat conductivity, so that the attachment does not transmit heat to the O-ring sealing element.

Advantageously, the attachment is formed as a tubular attachment, e.g., as a tube. Advantageously, the vacuum pump housing is also formed at least partially of aluminum. This makes the pump lighter because an aluminum housing is lighter than a conventional heavy stainless steel housing which is used, as is known from practice, with CF-sealing elements.

According to a further advantageous embodiment of the invention, at least the connection flange of the vacuum pump for connection with the recipient is formed of aluminum. With this, the reduction of weight also becomes possible. The formation of the connection flange of aluminum become possible as no CF-flange with a metal sealing element must be used, rather than O-ring sealing with at least one elastomeric O-ring is used.

The attachment, which is provided between the recipient housing the vacuum pump has advantageously a wall thickness from 1 mm to 10 mm.

In order to obtain an air-tight and fixed connection between the attachment and the recipient housing, the attachment is advantageously welded to the housing. However, it is also possible to provide other vacuum-tight connections between the attachment and the housing.

According to a further advantageous embodiment of the invention, it is also possible to form the attachment and the recipient housing as a one-piece member.

The attachment has at its end opposite the recipient a flange for connection with the vacuum pump. In this region at least one O-ring sealing element is provided. Thereby a conventional flange connection with the vacuum pump can be provided.

The attachment flange is connected with a connection flange of the vacuum pump by screw means. This is a very simple type of connection. It is also possible to use clip means and other connecting means for a releasable connection of flanges.

Advantageously, at least one O-ring is provided between the flanges of the attachment and the vacuum pump as a sealing element. The advantage of this consists in that the O-ring is displaced axially from the housing of the recipient in the direction of the vacuum pump so that heating of the recipient does not have any negative effect on the elastomering O-ring.

According to an advantageous embodiment of the invention, the vacuum pump has a tubular piece that is at least partially received in the attachment which is arranged between the recipient housing and the vacuum pump. The tubular piece additionally blocks fumigation and leakage which may occur in vacuum when an O-ring sealing element is used.

A higher pressure level in the region of the O-ring sealing has an advantage that consists in that the O-ring sealing has a noticeably smaller fumigation or not all.

In addition, it is advantageous when a clearance is provided between the tubular piece of the vacuum pump and the attachment which is arranged between the recipient and the vacuum pump. According to a particularly advantageous embodiment of the invention, an intermediate suction from this narrow clearance or slot is provided. To this end, the tubular piece is advantageously provided with at least one opening for suction of gases. Thereby, the number of particles which penetrates in the UHV-region as a result of fumigation can be minimized.

Advantageously, the tubular piece of the vacuum pump has at least one collection groove, and wherein the at least one or more openings for suction of gases is (are) provided in the at least one collection groove.

Advantageously, the tubular piece is formed of stainless steel or aluminum. The vacuum system according to the present invention has advantageously a vacuum pump that is formed as a turbomolecular pump. Particularly advantageously, the vacuum system has a pump that is formed as a split flow pump. It is particularly advantageous to use turbomolecular and split flow pumps in the UHV-region.

The inventive construction has an additional advantage that consists in that the pump can be placed closer to the recipient because in practice, with the use of CF-flanges, an axial length of the construction is reduced and thereby, the location for the screw connection can be provided in the region of the pump housing. Thereby, the volume of the construction is reduced, and the conductance with regard to an effective suction capacity is increased. A further advantage of the invention consists in the possibility to re-use the sealing element.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

The drawings show:

FIG. 1 a schematic, partially cross-sectional view of a vacuum system with a vacuum pump and a recipient according to the present invention; and

FIG. 2 a schematic partially cross-sectional view of another embodiment of a vacuum system according to the present invention.

### DETAILED DESCRIPTION OF THE PREFERRED EMBODIMENTS

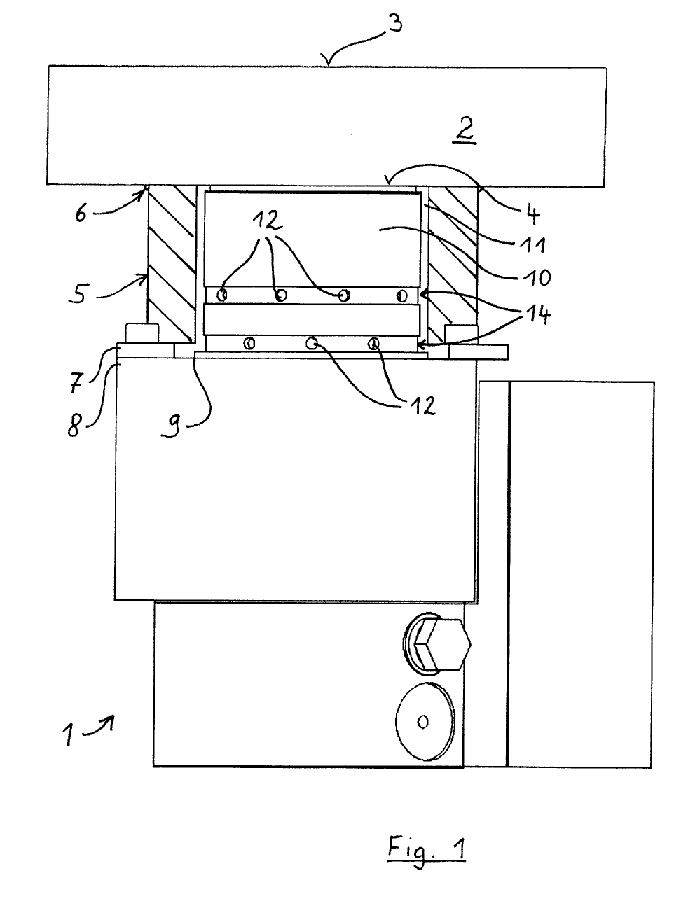

FIG. 1 shows a vacuum pump 1 and a recipient 2. The recipient 2 has a housing 3 shown in elevational view. The housing 3 has an outlet opening 4. A tube 5 covers the outlet opening 4 of the housing 3 of the recipient 2. The tube 5 is fixedly and vacuum-tightly secured on the housing 3 by a welding connection 6. The tube 5 has a flange 7 releasably connectable with the flange 8 of the vacuum pump 1. Between the flanges 7 and 8, a sealing 9 in form of an O-ring is provided. The tube 5 provides for an axial displacement of the O-ring sealing 9 in a direction from a forevacuum side to a high-pressure side. In the tube 5, a tubular piece 10 is arranged. The tubular piece 10, which forms part of the vacuum pump 1, is shown in elevational view. Between the tubular piece 10 and the tube 5, a clearance 11 is provided. In addition, suction openings 12 for an intermediate suction are provided in the tubular piece 10. The suction openings 12 are provided in grooves 14 which are formed as collection grooves. Thereby, the suction openings and an allowable leakage which can take place in vacuum when O-ring sealing 9 is used, are shut off from UHV (ultra high vacuum) of the recipient 2. The suction openings 12 provide for suction of the occurring particles in a turboregion of the turbomolecular pump 1. Thereby, the number of particles entering the UH-region is minimized.

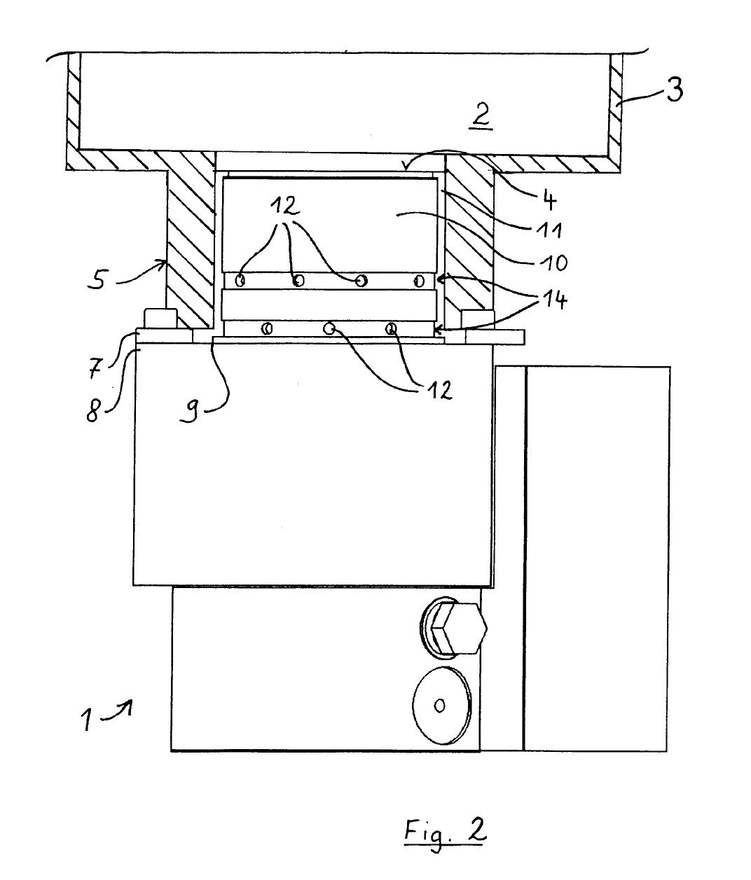

FIG. 2 likewise shows a vacuum system with vacuum pump 1 and a recipient 2. In FIG. 2 the elements identical to those in FIG. 1, are designated with the same reference numerals. In the embodiment shown in FIG. 2, the housing 3 and the tube 5 are formed as a one-piece member.

Though the present invention was shown and described with references to the preferred embodiments, such are merely illustrative of the present invention and is not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A vacuum system, comprising at least one recipient having a housing and at least one outlet opening for evacuating the recipient; a vacuum pump connected with the at least one outlet opening of the at least one recipient for evacuating same; an attachment provided between the vacuum pump and the recipient housing and formed as an intermediate piece, the attachment being fixedly and vacuum-tightly secured on the recipient, and the vacuum pump being fixedly and releasably secured to the attachment at an end of the attachment opposite the recipient; and at least one O-ring sealing element provided between the end of the attachment opposite the recipient and the vacuum pump for sealing the vacuum pump, the O-ring sealing element being formed as an elastomeric O-ring.

2. A vacuum system according to claim 1, wherein the attachment is formed as one of tube and tubular attachment.

3. A vacuum system according to claim 1, wherein the attachment is formed of one of stainless steel and aluminum.

4. A vacuum system according to claim 1, wherein a housing of the vacuum pump is formed at least partially of aluminum.

5. A vacuum system according to claim 4, wherein at least a connection flange of the vacuum pump facing the recipient is formed of aluminum.

6. A vacuum system according to claim 1, wherein the attachment has a wall thickness from 1 mm to 10 mm.

7. A vacuum system according to claim 1, wherein the attachment is welded to the recipient housing.

8. A vacuum system according to claim 1, wherein the attachment and the recipient housing are formed as a one-piece member.

9. A vacuum system according to claim 1, wherein the attachment has at the end thereof opposite the recipient a flange for connection with the vacuum pump.

10. A vacuum system according to claim 9, wherein the attachment flange is connected with a connection flange of the vacuum pump by screw means.

11. A vacuum system according to claim 10, wherein at least one O-ring sealing is provided between the attachment flange and the connection flange of the vacuum pump.

12. A vacuum system according to claim 1, wherein the vacuum pump comprises a tubular piece that is at least partially received in the attachment secured to the recipient housing.

13. A vacuum system according to claim 12, wherein the tubular piece has at least one opening for suction of gases.

14. A vacuum system according to claim 13, wherein the tubular piece of the vacuum pump has at least one collection groove, and wherein the at least one opening for suction of gases is provided in the at least one collection groove.

15. A vacuum system according to claim 12, wherein the tubular piece is formed of one of stainless steel and aluminum.

16. A vacuum system according to claim 1, wherein the vacuum pump is formed as a turbomolecular pump.

17. A vacuum system according to claim 1, wherein the vacuum pump is formed as a split-flow pump.
